(19) United States
(12) Patent Application Publication
(10) Pub. No.: US 2006/0023380 A1
(43) Pub. Date: Feb. 2, 2006

(54) ESD circuit used in a multi-voltage system

(75) Inventor: Chao-Hsin Lu, Ta Yuan Hsiang (TW)

Correspondence Address: BIRCH STEWART KOLASCH & BIRCH, PO BOX 747, FALLS CHURCH, VA, 22040-0747, US

(73) Assignee: Realtek Semicoductor Corp.

(21) Appl. No.: 11/193,365

(22) Filed: Aug. 1, 2005

(30) Foreign Application Priority Data
Aug. 2, 2004 (TW) 093123140

(51) Int. Cl. H02H 9/00

(52) U.S. Cl. 361/56

(57) ABSTRACT

An ESD (Electrostatic Discharge) circuit used in a multi-voltage system for protecting the system from electrostatic discharge between a first voltage source and at least one second voltage source. The ESD circuit includes a voltage bus, a first ESD protection circuit coupled between the first voltage source and the voltage bus, and a second ESD protection circuit coupled between the voltage bus and the second voltage source. The first ESD protection circuit includes an ESD detecting unit for detecting an electrostatic voltage and generating a trigger signal, and an ESD discharge unit for receiving the trigger signal of the ESD detecting unit and discharging an electrostatic current according to the trigger signal.

This application claims the benefit of the filing date of Taiwan Application Ser. No. 093123140, filed on Aug. 2, 2004, the content of which is incorporated herein by reference.

### BACKGROUND OF THE INVENTION

1. Field of the Invention

The invention relates to an ESD (Electrostatic Discharge) circuit, and more particular to an ESD circuit used in a multi-voltage system.

2. Description of the Related Art

FIG. 1 shows a conventional ESD protection module 10 disclosed in U.S. Pat. No. 6,075,686. Referring to FIG. 1, the ESD protection module 10 summates diode turn voltages of K cascaded diodes 11 and M reverse cascaded diodes 12 in order to isolate the first voltage source V_{DD1} from the second voltage source V_{DD2}.

However, when the voltage of the first voltage source V_{DD1} is much higher than that of the second voltage source V_{DD2}, the number (K) of the diodes correspondingly increases. As the number of the serially-connected diodes increases, the resistance of the discharge circuit increases. Thus the electrostatic charges cannot be discharged rapidly. In addition, when the ESD protection modules 10 are placed between two voltage sources, the number of the ESD protection modules 10 increases as the number of other voltage sources increases, resulting in the larger overall size of the overall circuit. For example, when the number of the voltage sources increases to 4, meaning that the overall circuit has four voltage levels, the number of the ESD protection modules 10 increases to six for the ESD protections have to lie between two voltage sources.

Thus, it is important to provide an ESD circuit capable of rapidly discharging electrostatic charges, protecting a circuit having a plurality of voltage sources, and reducing the overall size of the circuit.

### SUMMARY OF THE INVENTION

It is therefore an object of the invention to provide an ESD circuit having a 10 bus and being used in a multi-voltage system, wherein the ESD circuit can rapidly discharge electrostatic charges and effectively protect an integrated circuit (IC).

Another object of the invention is to provide an ESD circuit having a bus and being used in a multi-voltage system, wherein the ESD circuit can protect the circuit having a plurality of voltage sources and reduce the overall size of the circuit.

To achieve the above-mentioned objects, the invention provides an ESD circuit used in a multi-voltage system to protect a first voltage source and at least one second voltage source. The ESD circuit includes a voltage bus, a first ESD protection circuit coupled between the first voltage source and the voltage bus, and a second ESD protection circuit coupled between the voltage bus and the second voltage source.

The first ESD protection circuit includes an ESD detecting unit for detecting an electrostatic voltage and generating a trigger signal, and an ESD discharge unit for receiving the trigger signal of the ESD detecting unit and discharging an electrostatic current according to the trigger signal.

In addition, the use of the bus in conjunction with the first ESD protection circuit and the second ESD protection circuit can protect the first voltage source as well as the at least one second voltage source and reduce the overall size of the circuit.

### BRIEF DESCRIPTION OF THE DRAWINGS

FIG. 1 shows a conventional ESD protection module.

FIG. 2 shows an ESD protection circuit of the invention.

FIG. 3 shows an ESD circuit used in a multi-voltage system according to a first embodiment of the invention.

FIG. 4 shows an ESD circuit used in a multi-voltage system according to a second embodiment of the invention.

### DETAILED DESCRIPTION OF THE INVENTION

The ESD circuit having a bus according to the present invention will be described with reference to the accompanying drawings, wherein the same symbols denotes the same elements.

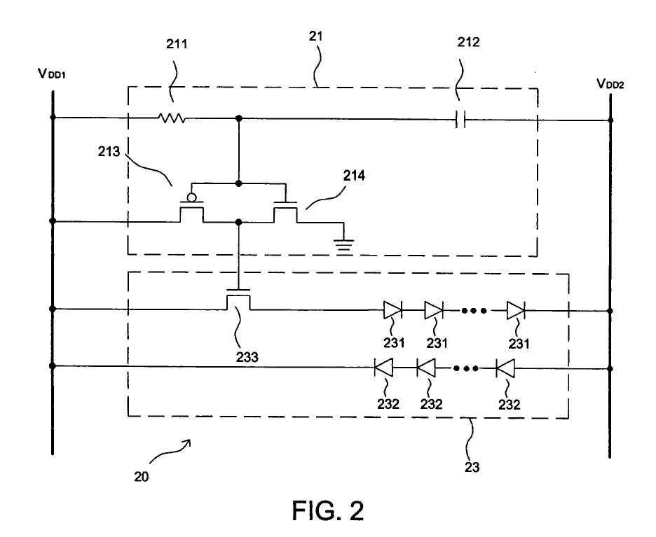

FIG. 2 shows a first embodiment of an ESD protection circuit of the invention. As shown in FIG. 2, the ESD protection circuit 20 protects a first voltage source V_{DD1} and a second voltage source V_{DD2} by discharging an electrostatic current therebetween. In this embodiment, the voltage of the first voltage source V_{DD1} is higher than the voltage of the second voltage source V_{DD2}. The ESD protection circuit 20 includes an ESD detecting unit 21 and an ESD discharge unit 23.

In this embodiment, the ESD detecting unit 21 for detecting the electrostatic voltage includes a resistor 211 and a capacitor 212. In another embodiment, the ESD detecting unit 21 may further include a PMOS transistor 213 and an NMOS transistor 214. The ESD detecting unit 21 of FIG. 2 is just one embodiment, and any other circuits capable of detecting the electrostatic voltage and generating the trigger signal can be implemented in the invention. In this embodiment, the resistor 211 is coupled to the first voltage source V_{DD1}. The capacitor 212 is coupled between the resistor 211 and the second voltage source V_{DD2}. The PMOS transistor 213 has a source coupled to the first voltage source V_{DD1}, and a gate coupled to the point between the resistor 211 and the capacitor 212. A drain of the NMOS transistor 214 is coupled to a drain of the PMOS transistor 213, a gate of the NMOS transistor 214 coupled to the gate of the PMOS transistor 213, and a source of the NMOS transistor 214 grounded. The drain of the NMOS transistor 214 or/and the drain of the PMOS transistor 213 is defined as the terminal for outputting the trigger signal, and the voltage of the drain is defined as the trigger voltage.

The ESD discharge unit 23 includes a switch 233, K forward diodes 231 connected in series, and M reverse diodes 232 connected in series. The switch 233 may be implemented by a transistor, and be controlled by the trigger signal. The K diodes 231 coupled between the switch 233 and the second voltage source V_{DD2} enable the electrostatic current to flow from the first voltage source V_{DD1} to the second voltage source V_{DD2} through the switch 233 and the diodes 231 after the switch 233 is turned on. The diodes 231 are optionally placed. The M diodes 232 coupled between the first voltage source V_{DD1} and the second voltage source V_{DD2} serve as the discharge path for the negative ESD. As the discharge path of the positive ESD is controlled by the switch 233, the resistance of the discharge path is relatively small, and the discharge efficiency can thus be enhanced.

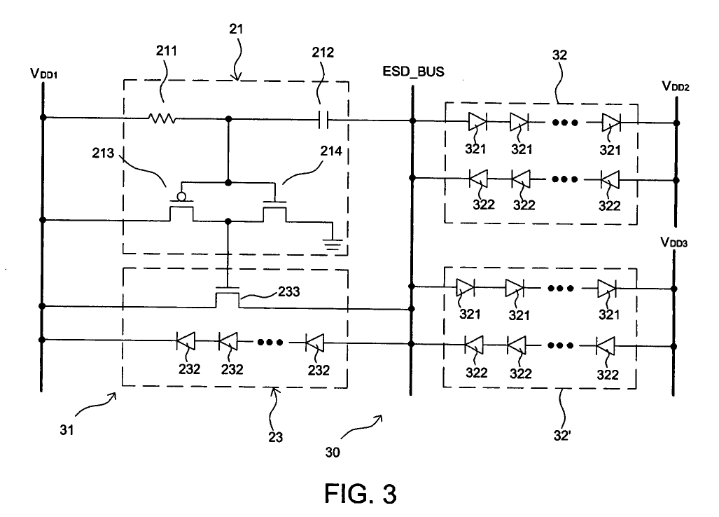

FIG. 3 shows an ESD circuit used in a multi-voltage system according to a second embodiment of the invention. The ESD circuit 30 protects a first voltage source V_{DD1}, a second voltage source V_{DD2}, and a third voltage source V_{DD3} by discharging the electrostatic current. In this embodiment, the voltage of the first voltage source V_{DD1} is much higher than the voltage of the second voltage source V_{DD2} or the third voltage source V_{DD3}, and the voltage difference between the second and third voltage sources V_{DD2} and V_{DD3} is smaller. The ESD circuit 30 includes a voltage bus ESD_BUS, a first ESD protection circuit 31, a second ESD protection circuit 32 and a third ESD protection circuit 32′.

The first ESD protection circuit 31 is coupled between the first voltage source V_{DD1} and the voltage bus ESD_BUS in order to bypass the electrostatic current from the first voltage source V_{DD1} to the voltage bus ESD_BUS under the control of the switch 233 when an electrostatic current flows into the first voltage source V_{DD1}. As the voltage of the first voltage source V_{DD1} is much higher than the voltage of the second voltage source V_{DD2} or the third voltage source V_{DD3}, the first ESD protection circuit 31 may be implemented by the ESD circuit of FIG. 2, meaning that the first ESD protection circuit 31 includes an ESD detecting unit 21 and an ESD discharge unit 23. The ESD detecting unit 21 and the ESD discharge unit 23 have the same architectures and functions as mentioned above, thus detailed descriptions thereof will be omitted.

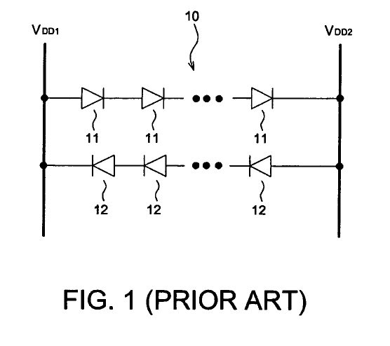

The second ESD protection circuit 32 is coupled between the voltage bus ESD_BUS and the second voltage source V_{DD2}, and the third ESD protection circuit 32′ is coupled between the voltage bus ESD_BUS and the third voltage source V_{DD3}. As the voltage difference between the second and third voltage sources V_{DD2} and V_{DD3} is smaller, the second ESD protection circuit 32 and the third ESD protection circuit 32′ may be implemented by a conventional ESD protection circuit showed in FIG. 1. Consequently, the second ESD protection circuit 32 and the third ESD protection circuit 32′ do not have to include too many diodes. Thus the resistance of the ESD path may be effectively reduced, and the speed for discharging the electrostatic charges can be increased. The numbers of diodes in the second ESD protection circuit 32 and the third ESD protection circuit 32′ are determined according to the voltage difference between the second and third voltage sources V_{DD2} and V_{DD3}. If the voltage difference between the second and third voltage sources V_{DD2} and V_{DD3} is greater than a certain voltage value, the second ESD protection circuit 32 and/or the third ESD protection circuit 32′ also may be implemented by the ESD circuit of FIG. 2.

The ESD circuit 30 utilizes the voltage bus ESD_BUS to protect the first, second and third voltage sources V_{DD1}, V_{DD2} and V_{DD3} by discharging the electrostatic current, and the circuit design is simple. When a positive electrostatic voltage occurs between the first voltage source V_{DD1} and the second voltage source V_{DD2}, the ESD detecting unit 21 generates a trigger signal to turn on the transistor 233 of the ESD discharge unit 23, and to bypass the electrostatic current from the first voltage source V_{DD1} to the second voltage source V_{DD2} through the transistor 233 and the ESD protection circuit 32. When there is a negative electrostatic voltage between the first voltage source V_{DD1} and the second voltage source V_{DD2}, the electrostatic current is bypassed from the second voltage source V_{DD2} to the first voltage source V_{DD1} through the ESD protection circuit 32 and the cascaded diodes 232. When there is a positive electrostatic voltage between the second and third voltage sources V_{DD2} and V_{DD3}, the electrostatic current is bypassed from the second voltage source V_{DD2} to the voltage bus ESD_BUS through the cascaded diodes 322 of the ESD protection circuit 32, and then bypassed from the voltage bus ESD_BUS to the third voltage source V_{DD3} through the cascaded diodes 321 of the third ESD protection circuit 32′. When there is a negative electrostatic voltage between the second and third voltage sources V_{DD2} and V_{DD3}, the electrostatic current is bypassed from the third voltage source V_{DD3} to the voltage bus ESD_BUS through the cascaded diodes 322 of the third ESD protection circuit 32′, and then bypassed from the voltage bus ESD_BUS to the second voltage source V_{DD2} through the cascaded diodes 321 of the ESD protection circuit 32.

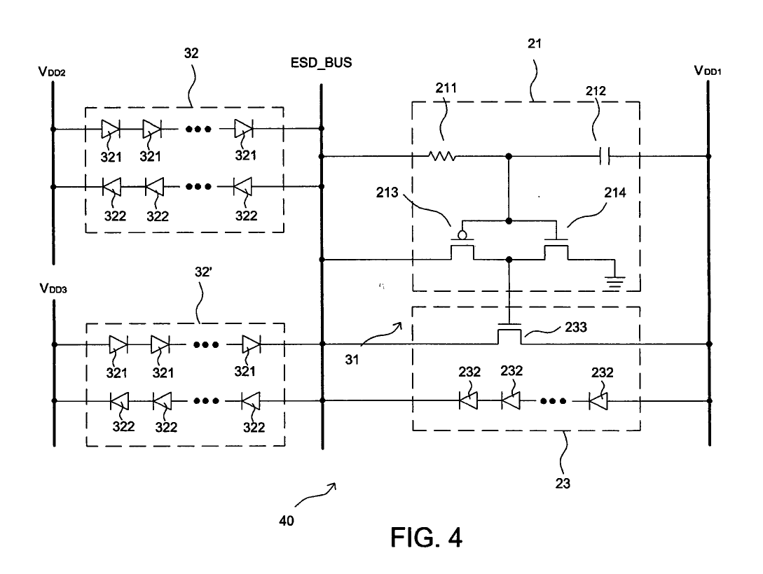

FIG. 4 shows an ESD circuit used in a multi-voltage system according to a third embodiment of the invention. The ESD circuit 40 protects a first voltage source V_{DD1}, a second voltage source V_{DD2}, and a third voltage source V_{DD3} by discharging the electrostatic current. In this embodiment, the voltage of the first voltage source V_{DD1} is much lower than the voltages of the second or third voltage source V_{DD2} or V_{DD3}, and the voltage difference between the second and third voltage sources V_{DD2} and V_{DD3} is smaller. Similar to the ESD circuit 30 of FIG. 3, the ESD circuit 40 includes a voltage bus ESD_BUS, a first ESD protection circuit 31, a second ESD protection circuit 32 and a third ESD protection circuit 32′, except that the voltage of the first voltage source V_{DD1} is much lower than the voltages of the second or third voltage source VDD₂ or VDD₃.

Therefore, when a positive electrostatic voltage occurs between the second voltage source V_{DD2} and the first voltage source V_{DD1}, the ESD detecting unit 21 generates a trigger signal to turn on the transistor 233 of the ESD discharge unit 23 and to bypass the electrostatic current to the first voltage source V_{DD1} through the ESD protection circuit 32 and the transistor 233. When a negative electrostatic voltage occurs between the second voltage source V_{DD2} and the first voltage source V_{DD1}, the electrostatic current is bypassed from the first voltage source V_{DD1} to the second voltage source V_{DD2} through the cascaded diodes 232 and the ESD protection circuit 32.

While certain exemplary embodiments have been described and shown in the accompanying drawings, it is to be understood that such embodiments are merely illustrative of and not restrictive on the broad invention, and that this invention not be limited to the specific construction and arrangement shown and described, since various other modifications may occur to those ordinarily skilled in the art.

What is claimed is:

1. An ESD (Electrostatic Discharge) circuit used in a multi-voltage system, wherein the multi-voltage system comprises a first voltage source and a second voltage source, the ESD circuit comprising:
a voltage bus;
a first ESD protection circuit coupled between the first voltage source and the voltage bus; and
a second ESD protection circuit coupled between the voltage bus and the second voltage source.

2. The ESD circuit according to claim 1, wherein the first ESD protection circuit comprises:
an ESD detecting unit for detecting an electrostatic voltage and generating a trigger signal; and
an ESD discharge unit coupled to the ESD detecting unit and discharging an electrostatic current according to the trigger signal.

3. The ESD circuit according to claim 2, wherein the ESD discharge unit comprises a negative ESD protection unit for bypassing the electrostatic current from the voltage bus to the first voltage source when there is a negative electrostatic voltage between the first voltage source and the voltage bus.

4. The ESD circuit according to claim 2, wherein the ESD detecting unit comprises:
a resistor; and
a capacitor coupled to the resistor to form a terminal for outputting the trigger signal.

5. The ESD circuit according to claim 2, wherein the ESD detecting unit comprises:
a resistor;
a capacitor coupled to the resistor;
a PMOS transistor having a gate coupled between the resistor and the capacitor; and
an NMOS transistor having a gate coupled to the gate of the PMOS transistor and a drain coupled to a drain of the PMOS transistor to form a terminal for outputting the trigger signal.

6. The ESD circuit according to claim 2, wherein the ESD discharge unit is a switch for receiving the trigger signal and the switch is turned on when the trigger signal is higher than a threshold value.

7. The ESD circuit according to claim 1, wherein the second ESD protection circuit comprises cascaded diodes.

8. An ESD (Electrostatic Discharge) circuit used in a multi-voltage system, which comprises a first voltage source, a second voltage source and a third voltage source, the ESD circuit comprising:
a voltage bus;
a first ESD protection circuit coupled between the first voltage source and the voltage bus;
a second ESD protection circuit coupled between the voltage bus and the second voltage source; and
a third ESD protection circuit coupled between the voltage bus and the third voltage source.

9. The ESD circuit according to claim 8, wherein the first ESD protection circuit comprises:
an ESD detecting unit for detecting an electrostatic voltage and generating a trigger signal; and
an ESD discharge unit coupled to the ESD detecting unit and discharging an electrostatic current according to the trigger signal.

10. The ESD circuit according to claim 9, wherein the first ESD protection circuit further comprises a negative ESD protection unit for bypassing the electrostatic current from the voltage bus to the first voltage source when there is a negative electrostatic voltage between the first voltage source and the voltage bus.

11. The ESD circuit according to claim 9, wherein the ESD detecting unit comprises:
a resistor; and
a capacitor coupled to the resistor to form a terminal for outputting the trigger signal.

12. The ESD circuit according to claim 9, wherein the ESD detecting unit comprises:
a resistor;
a capacitor coupled to the resistor;
a PMOS transistor having a gate coupled between the resistor and the capacitor; and
an NMOS transistor having a gate coupled to the gate of the PMOS transistor and a drain coupled to a drain of the PMOS transistor to form a terminal for outputting the trigger signal.

13. The ESD circuit according to claim 9, wherein the ESD discharge unit is a switch for receiving the trigger signal and the switch is turned on when the trigger signal is higher than a threshold value.

14. The ESD circuit according to claim 13, wherein the switch is a transistor.
